(19) United States
(12) Patent Application Publication
(10) Pub. No.: US 2008/0110362 A1
(43) Pub. Date: May 15, 2008

(54) Magazine for printing units, particularly for printing machines

(75) Inventor: Federico D'Annunzio, Cislago (IT)

Correspondence Address: MODIANO & ASSOCIATI, Via Meravigli, 16, Milan, 20123, omitted

(73) Assignee: GIDUE S.p.A.

(21) Appl. No.: 11/907,308

(22) Filed: Oct. 11, 2007

(30) Foreign Application Priority Data
Nov. 10, 2006 (IT) MI2006A002163

(51) Int. Cl. B41F 27/00

(52) U.S. Cl. 101/477

(57) ABSTRACT

A magazine for printing units for printing machines, comprising at least one track which is adapted to be arranged proximate to a printing machine and allows engagement of a plurality of printing units, further comprising at least one parking track, which is connected to the at least one track, in order to allow the parking of at least one printing unit which is coupled to the at least one track.

The present invention relates to a magazine for printing units, particularly for printing machines. More particularly, the invention relates to a magazine for printing units for flexographic, screen, offset, gravure, hot stamping, die-cutting, lamination printing machines and the like.

### BACKGROUND OF THE INVENTION

As is known, printing machines of the type cited above are provided with printing units which have to be changed according to the type of printing to be performed on a specific medium. In particular, printing units can be changed from flexographic to screen, offset, gravure, hot stamping, die-cutting, lamination and the like. Currently, printing units can be arranged along a track which hangs in front of the printing machine, such units being ready to be placed in position in the corresponding printing machine. However, because of the alignment of the printing units, if one wishes to move a printing unit in front of another and vice versa, this is not possible, due to the protection of a single track, and therefore the preselected order of the printing units cannot be changed during operation of the printing machine.

This drawback causes the printing machine to be inflexible, since it cannot be adapted easily to new printing requirements which require new printing units, which therefore might not be in the position suitable to be placed in the operating condition on the printing machine.

Substantially, there is the need to have an interchange of printing units without this interchange being constrained by the presence of a single track which forces an alignment of the printing heads.

### SUMMARY OF THE INVENTION

The aim of the present invention is to provide a magazine for printing units which allows to arrange the units in position even in a non-aligned position, so as to allow rapid replacement with the most appropriate unit.

Within this aim, an object of the present invention is to provide a magazine for printing units which can be used in combination with one or more printing machines.

Another object of the present invention is to provide a magazine for printing units which can be combined with the flexographic, screen, offset, gravure, hot stamping, die-cutting, lamination printing machine and the like.

Still another object of the present invention is to provide a magazine for printing units which is highly reliable, relatively simple to provide and at competitive costs.

This aim and these and other objects, which will become better apparent hereinafter, are achieved by a magazine for printing units for printing machines, comprising at least one track which is arranged proximate to the printing machine, said track allowing the engagement of a plurality of printing units, characterized in that it comprises at least one parking track, which is connected to said at least one track, in order to allow the parking of at least one printing unit which is coupled to said at least one track.

### BRIEF DESCRIPTION OF THE DRAWINGS

Further characteristics and advantages of the invention will become better apparent from the description of preferred but not exclusive embodiments of the magazine according to the present invention, illustrated by way of non-limiting example in the accompanying drawing, wherein:

FIG. 1 is a schematic top plan view of a printing machine with the magazine according to the present invention; and

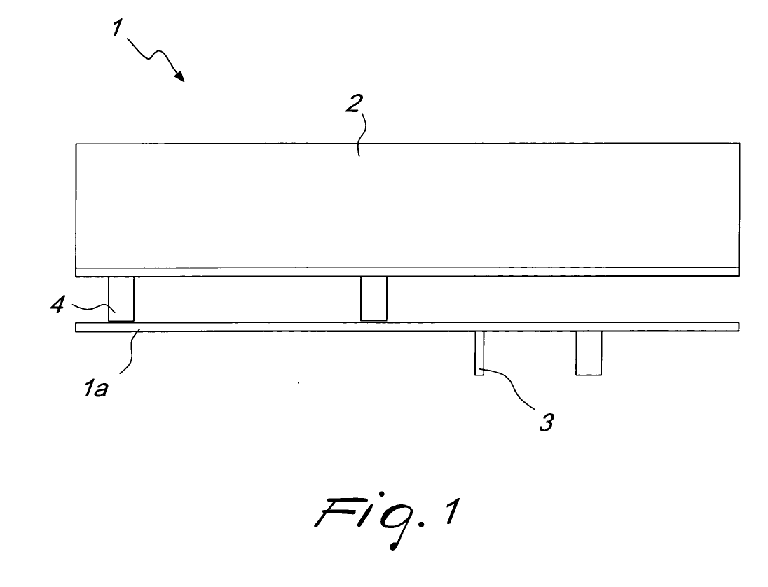

FIG. 2 is a view of a second embodiment of the present invention.

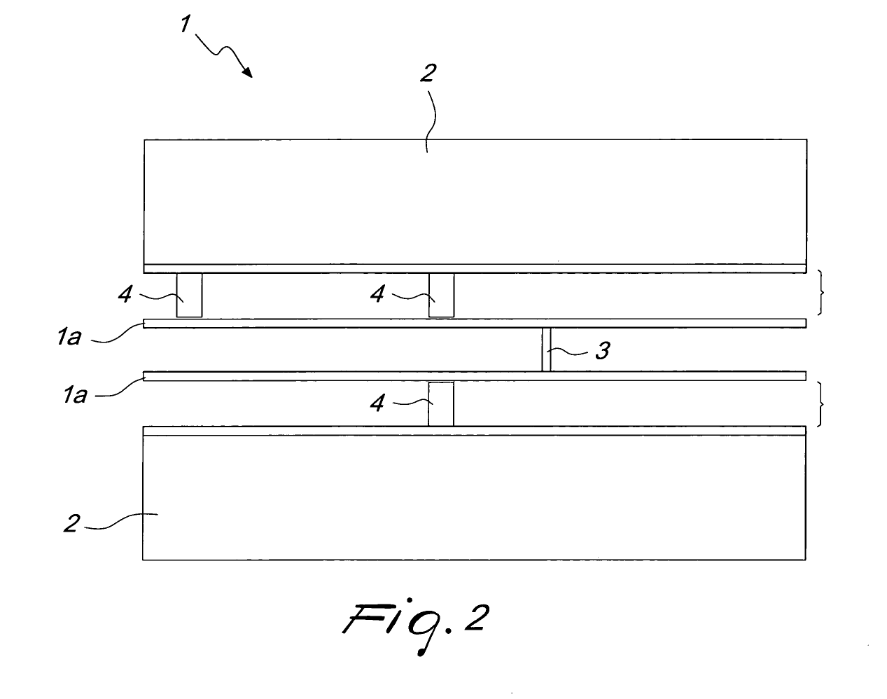

### DESCRIPTION OF THE PREFERRED EMBODIMENTS

With reference to the figures, the magazine according to the present invention, generally designated by the reference numeral 1, comprises at least one track, which is adapted to be arranged above a printing machine 2, which can be a flexographic, screen, offset, gravure, hot stamping, die-cutting, and lamination printing machine.

Preferably, the track 1a is arranged along the extension of the printing machine 2, parallel thereto, and the peculiarity of the invention resides in that it has at least one parking track 3, which is preferably arranged at right angles to the track 1a and is adapted to allow to park the printing units 4 that are engaged with the track 1a. Substantially, the parking track 3 allows to park at least one unit 4 so as to allow the aligned units 4 to be extracted, so as to place the selected unit in position on the printing machine.

Accordingly, this allows to avoid the need to move the unit manually and put it in position, but allows to replace it substantially automatically, eliminating the drawback of having aligned units, so that it is not possible to bring one unit in front of another although initially the first unit was behind the other one.

This problem is in fact solved by the presence of the parking track 3, which allows to “break” the row of units, thus allowing to reach the selected unit.

Conveniently, the track 1a can be arranged above a printing machine 2, as mentioned earlier, or can be arranged so as to be shared by two facing printing machines 2. Also, moreover, it is possible to provide two tracks 1a which are parallel one another and at least one or more parking tracks 3 which interconnect the two parallel tracks 1a.

In practice it has been found that the magazine according to the present invention fully achieves the intended aim and objects, since it allows to obviate the drawbacks of having printing units which are aligned on a single track and therefore cannot be positioned in the selected position at the chosen time.

The invention in fact allows to move the printing units, optionally parking them on a parking track, in order to be able to reach the selected printing unit and install it on the printing machine.

The magazine thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. MI2006A002163 from which this application claims priority are incorporated herein by reference.

What is claimed is:

1. A magazine for printing units for printing machines, comprising at least one track which is arranged proximate to a printing machine, said track allowing engagement of a plurality of printing units, further comprising at least one parking track, which is connected to said at least one track, in order to allow parking of at least one printing unit which is coupled to said at least one track.

2. The magazine according to claim 1, wherein at least one parking track is arranged at right angles to said at least one track.

3. The magazine according to claim 1, wherein said at least one track is arranged substantially parallel to the extension of said printing machine and above said printing machine, said at least one parking track being arranged at right angles to said at least one track.

4. The magazine according to claim 1, comprising a pair of tracks which are parallel and adapted to be arranged proximate to a pair of printing machines, at least one parking track interconnecting said two tracks.
